(19) United States
(12) Patent Application Publication
(10) Pub. No.: US 2026/0106295 A1
(43) Pub. Date: Apr. 16, 2026

(54) BATTERY MODULE

(71) Applicant: SAMSUNG SDI CO., LTD., Yongin-si (KR)

(72) Inventors: Jun Hwa PARK, Suwon-si (KR); Dae Yon MOON, Suwon-si (KR); Beom Joo KIM, Suwon-si (KR); Woong Jip KANG, Suwon-si (KR); Sang Myeong KIM, Suwon-si (KR); Han Young CHOI, Suwon-si (KR)

(21) Appl. No.: 19/345,775

(22) Filed: Sep. 30, 2025

(30) Foreign Application Priority Data
Oct. 15, 2024 (KR) 10-2024-0140647

(51) Int. Cl. H01M 50/242; H01M 10/04; H01M 50/209; H01M 50/264

(52) U.S. Cl. CPC H01M 50/242; H01M 10/0481; H01M 50/209; H01M 50/264

(57) ABSTRACT

A battery module includes a cell assembly including a plurality of battery cells; and a band that includes an elastic material, and surrounds the cell assembly while applying pressure, and each of the plurality of battery cells includes a case; and a pair of tabs extending from at least one side of the case and passing through the band.

### CROSS-REFERENCE TO RELATED APPLICATION

The present application claims priority to and the benefit of Korean Patent Application No. 10-2024-0140647, filed on Oct. 15, 2024, in the Korean Intellectual Property Office, the entire disclosure of which is incorporated herein by reference.

### BACKGROUND

### 1. Field

Aspects of embodiments of the present disclosure relate to a battery module.

### 2. Description of the Related Art

A battery cell can be charged and discharged. Low-capacity battery cells may be used for portable small-sized electronic devices, such as smartphones, feature phones, notebook computers, digital cameras, and camcorders, and high-capacity battery cells are widely used as power sources for driving a motor and power storage batteries in hybrid vehicles and electric vehicles. Such a battery cell includes electrodes including a positive electrode and/or a negative electrode, an electrode assembly including the electrodes, a case that accommodates the electrode assembly, and electrode terminals connected to the electrode assembly.

As technology advances, battery cells with high capacity are desired. Accordingly, a plurality of battery cells may be electrically connected and used. For example, the battery cells may be applied to an electronic device in the form of a battery module and/or a battery pack, which may include a plurality of battery cells. In this case, the electronic device is an electronic device that requires high power and/or high capacity and may include, for example, an electric vehicle.

The above-described information disclosed in the background technology of the present invention is provided to improve understanding of the background of the present invention and thus may include information that does not form the related art.

### SUMMARY

According to an aspect of embodiments of the present invention, a battery module including a band that pressurizes a battery cell is provided. According to an aspect of embodiments of the present invention, a battery module may eliminate or reduce a pressure imbalance.

However, aspects and problems to be solved by the present invention are not limited to the above-mentioned aspects and problems to be solved, and other aspects and problems to be solved not mentioned may be clearly understood by those skilled in the art from the following description.

According to one or more embodiments, a battery module includes a cell assembly including a plurality of battery cells; and a band which includes an elastic material and surrounds the cell assembly while applying pressure, and each battery cell includes a case; and a pair of tabs which extends from at least one side of the case and passes through the band.

According to an aspect of one or more embodiments of the present invention, a battery module which maintains a uniform or substantially uniform pressure if pressure changes due to swelling during charging and discharging is provided.

According to another aspect of one or more embodiments of the present invention, a battery module with improved stability and/or an improved lifespan is provided.

However, aspects, effects, and problems to be solved by the present invention are not limited to those mentioned above, and other aspects, effects, and problems to be solved not mentioned can be clearly understood by those skilled in the art from the following description.

### BRIEF DESCRIPTION OF THE DRAWINGS

The drawings appended to the present specification are provided to illustrate some embodiments of the present invention, and the spirit of the present invention will be more clearly understood from the accompanying drawings together with the following description of the invention; however, the present invention is not be construed as being limited to matters described in the drawings, in which:

FIG. 1 is a perspective view that schematically illustrates a battery cell according to an embodiment of the present invention;

FIG. 2 is a front view that schematically illustrates the battery cell of FIG. 1;

FIG. 3 is a perspective view that schematically illustrates a battery module according to an embodiment of the present invention;

FIG. 4 is a perspective view that schematically illustrates a battery module according to an embodiment of the present invention;

FIG. 5 is a perspective view that schematically illustrates a battery module according to an embodiment of the present invention;

FIGS. 6A and 6B schematically illustrate a band according to an embodiment of the present invention;

FIGS. 7A and 7B schematically illustrate a band according to an embodiment of the present invention;

FIG. 8 schematically illustrates a band according to an embodiment of the present invention;

FIG. 9 schematically illustrates a band according to an embodiment of the present invention; and

FIG. 10 schematically illustrates a band according to an embodiment of the present invention.

### DETAILED DESCRIPTION

Herein, some embodiments of the present invention will be described in further detail. However, these embodiments are presented as examples, and the present invention is not limited thereby, and the present invention is defined by the scope of the claims.

Unless otherwise specified herein, when a part, such as a layer, a film, a region, or a plate is described as being “on” another part, this includes not only a case in which the part is “directly on” another part, but also a case in which another part is present therebetween.

Unless otherwise specified herein, the singular expression may also include the plural. In addition, unless otherwise specified, “A or B” may mean “including A, including B, or including A and B.”

As used herein, “a combination thereof” may mean a mixture, a laminate, a composite, a copolymer, an alloy, a blend, a reaction product, and the like of components.

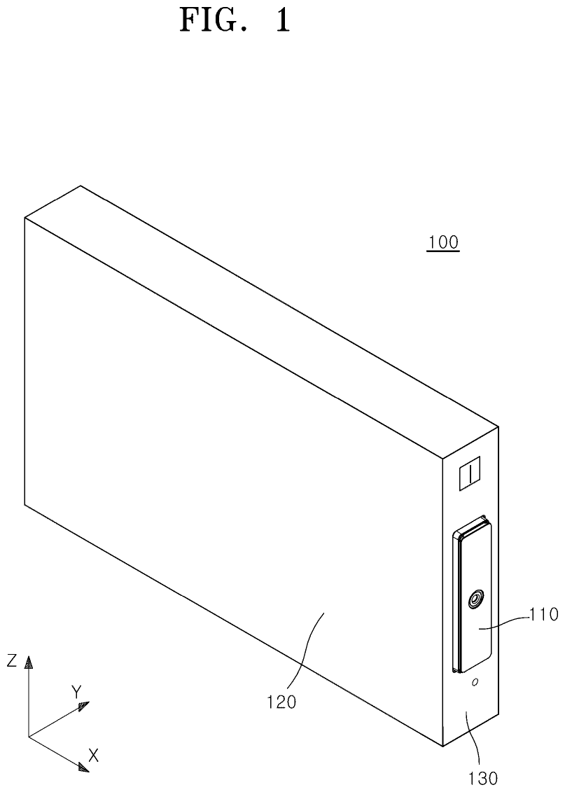

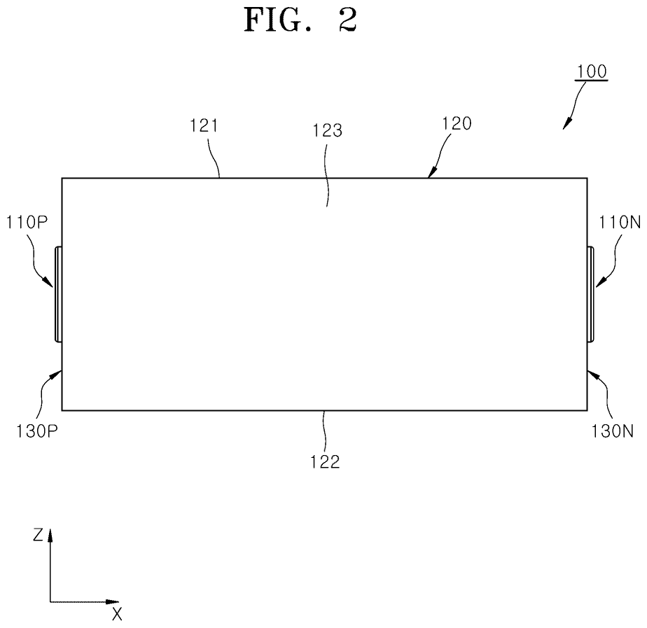

FIG. 1 is a perspective view that schematically illustrates a battery cell according to an embodiment of the present invention; and FIG. 2 is a front view that schematically illustrates the battery cell of FIG. 1.

In FIGS. 1 and 2, a battery cell 100 according to an embodiment of the present invention is shown. In addition, in FIGS. 1 and 2, an X axis represents a width direction of the battery cell 100. A Y axis represents a longitudinal direction of the battery cell 100. A Z axis represents a height direction of the battery cell 100. Here, the X axis is perpendicular to the Y axis and the Z axis, the Y axis is perpendicular to the X axis and the Z axis, and the Z axis is perpendicular to the X axis and the Y axis.

The battery cell 100 includes a case 120; and a pair of tabs 110 extending from at least one side of the case and passing through a band.

The battery cell 100 may include an electrode assembly having a separator interposed between a positive electrode and a negative electrode, and the case 120 accommodating the electrode assembly. The positive electrode, the negative electrode, and the separator may be impregnated with an electrolyte (not shown).

As a positive electrode active material, a compound (lithiated intercalation compound) which enables reversible intercalation and deintercalation of lithium may be used. In an embodiment, one or more of composite oxides of lithium and a metal selected from cobalt, manganese, nickel, and a combination thereof may be used.

The composite oxide may be a lithium transition metal composite oxide, and examples of the composite oxide may include a lithium nickel-based oxide, a lithium cobalt-based oxide, a lithium manganese-based oxide, a lithium iron phosphate-based compound, a cobalt-free nickel manganese-based oxide, or a combination thereof.

As an example, a compound represented by any of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

As an example, the positive electrode active material may be a high-nickel-based positive electrode active material having a nickel content of 80 mol % or greater, 85 mol % or greater, 90 mol % or greater, 91 mol % or greater, 94 mol % or greater, and 99 mol % or less based on 100 mol % of the metal, except lithium, in the lithium-transition metal composite oxide. The high-nickel-based positive electrode active material may realize high capacity and thus can be applied to a battery cell with high capacity and high density.

The positive electrode for the battery cell 100 may include a current collector and a positive electrode active material layer formed on the current collector. The positive electrode active material layer may include a positive electrode active material, and further include a binder and/or a conductive material.

As an example, the positive electrode may further include an additive which may serve as a sacrificial positive electrode.

In an embodiment, a content of the positive electrode active material may be 90 wt % to 99.5 wt % based on 100 wt % of the positive electrode active material layer, and a content of each of the binder and the conductive material may be 0.5 wt % to 5 wt % based on 100 wt % of the positive electrode active material layer.

The binder may adhere particles of the positive electrode active material to each other well, and adhere the positive electrode active material to the current collector well. Some representative examples of binders may include polyvinyl alcohol, carboxymethyl cellulose, hydroxypropyl cellulose, diacetyl cellulose, polyvinylchloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, and nylon, but the present invention is not limited thereto.

The conductive material provides conductivity to the electrode, and any suitable electrically conductive material that does not cause a chemical change may be used in the configured battery. Examples of the conductive material may include a carbon-based material, such as natural graphite, artificial graphite, carbon black, acetylene black, Ketjen black, carbon fibers, carbon nanofibers, or carbon nanotubes; a metal-based material in the form of a metal powder or metal fiber and containing copper, nickel, aluminum, or silver; a conductive polymer such as a polyphenylene derivative; or a mixture thereof.

As the current collector, Al may be used, but the present invention is not limited thereto.

The negative electrode active material may be a material capable of reversibly intercalating/deintercalating lithium ions, lithium metal, an alloy of lithium and a metal, a material capable of doping and dedoping lithium, or a transition metal oxide.

The material capable of reversibly intercalating/deintercalating lithium ions may be a carbon-based negative electrode active material, for example, crystalline carbon, amorphous carbon, or a combination thereof. An example of crystalline carbon may be graphite, such as amorphous, plate-shaped, flaky, spherical or fibrous natural or artificial graphite, and an example of amorphous carbon may be soft carbon or hard carbon, mesophase pitch carbide, or calcined coke.

In an embodiment, the alloy of lithium and a metal may be an alloy of lithium and a metal selected from Na, K, Rb, Cs, Fr, Be, Mg, Ca, Sr, Si, Sb, Pb, In, Zn, Ba, Ra, Ge, Al, and Sn.

As the material capable of doping and dedoping lithium, a Si-based negative electrode active material or a Sn-based negative electrode active material may be used. The Si-based negative electrode active material may be silicon, a silicon-carbon composite, SiOₓ (0<x≤2), a Si-Q alloy (where Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. According to an embodiment, the silicon-carbon composite may include silicon particles of which a surface is coated with amorphous carbon. For example, the silicon-carbon composite may include a secondary particle (core) in which silicon primary particles are agglomerated and an amorphous carbon coating layer (shell) located on the surface of the secondary particle. The amorphous carbon may also be located between the silicon primary particles, such that the silicon primary particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

The Si-based negative electrode active material or Sn-based negative electrode active material may be used in combination with a carbon-based negative electrode active material.

The negative electrode of the battery cell 100 includes a current collector, and a negative electrode active material layer located on the current collector. The negative electrode active material layer may include a negative electrode active material, and further include a binder and/or a conductive material.

In an embodiment, for example, the negative electrode active material layer may include 90 wt % to 99 wt % of the negative electrode active material, 0.5 wt % to 5 wt % of the binder, and 0 wt % to 5 wt % of the conductive material.

The binder may adhere particles of the negative electrode active material to each other well, and adhere the negative electrode active material to the current collector well. As the binder, a non-aqueous binder, an aqueous binder, a dry binder, or a combination thereof may be used.

The non-aqueous binder may be polyvinylchloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, and a combination thereof.

If an aqueous binder is used as the negative electrode binder, a cellulose-based compound that can impart viscosity may be further included. As the cellulose-based compound, one or more of carboxymethyl cellulose, hydroxypropylmethyl cellulose, methyl cellulose, or an alkali metal salt thereof may be used in combination. In an embodiment, as the alkali metal, Na, K, or Li may be used.

The dry binder may be a polymer material capable of being fiberized, for example, polytetrafluoroethylene, polyvinylidene fluoride, a polyvinylidene fluoride-hexafluoropropylene copolymer, polyethylene oxide, or a combination thereof.

The conductive material provides conductivity to the electrode, and any suitable electrically conductive material that does not cause a chemical change may be used in the configured battery. Examples of the conductive material may include a carbon-based material, such as natural graphite, artificial graphite, carbon black, acetylene black, Ketjen black, carbon fibers, carbon nanofibers, or carbon nanotubes; a metal-based material in the form of a metal powder or metal fiber and containing copper, nickel, aluminum, or silver; a conductive polymer, such as a polyphenylene derivative; or a mixture thereof.

The negative electrode current collector may be selected from copper foil, nickel foil, stainless steel foil, titanium foil, nickel foam, copper foam, a polymer substrate coated with a conductive metal, and a combination thereof.

In an embodiment, the electrolyte for the battery cell 100 includes a non-aqueous organic solvent and a lithium salt.

The non-aqueous organic solvent serves as a medium through which ions involved in the electrochemical reaction of the battery can move.

The non-aqueous organic solvent may be a carbonate-based solvent, an ester-based solvent, an ether-based solvent, a ketone-based solvent, an alcohol-based solvent, an aprotic solvent, or a combination thereof.

As the carbonate-based solvent, dimethyl carbonate (DMC), diethyl carbonate (DEC), dipropyl carbonate (DPC), methyl propyl carbonate (MPC), ethyl propyl carbonate (EPC), ethyl methyl carbonate (MEC), ethylene carbonate (EC), propylene carbonate (PC), or butylene carbonate (BC) may be used.

As the ester-based solvent, methyl acetate, ethyl acetate, n-propyl acetate, dimethyl acetate, methyl propionate, ethyl propionate, decanolide, mevalonolactone, valerolactone, or caprolactone may be used.

As the ether-based solvent, dibutyl ether, tetraglyme, diglyme, dimethoxyethane, 2-methyltetrahydrofuran, 2,5-dimethyltetrahydrofuran, or tetrahydrofuran may be used. In addition, as the ketone-based solvent, cyclohexanone may be used. As the alcohol-based solvent, ethyl alcohol or isopropyl alcohol may be used, and as the aprotic solvent, a nitrile such as R—CN (where R is a linear, branched or cyclic hydrocarbon group having 2 to 20 carbon atoms, and includes a double bond, an aromatic ring, or an ether bond); an amide such as dimethyl formamide; a dioxolane such as 1,3-dioxolane and 1,4-dioxolane; or a sulfolane may be used.

The above examples of non-aqueous organic solvents may be used alone or in combination of two or more thereof.

In an embodiment, if a carbonate-based solvent is used, a cyclic carbonate and a chain carbonate may be mixed and used, and the cyclic carbonate and the chain carbonate may be mixed in a volume ratio of 1:1 to 1:9.

The lithium salt is a material that is dissolved in the organic solvent and serves as a source of lithium ions in a battery to enable the basic operation of a battery cell, and promotes the movement of lithium ions between positive and negative electrodes. Some representative examples of lithium salts may include one or two or more selected from among LiPF₆, LiBF₄, LiSbF₆, LiAsF₆, LiClO₄, LiAlO₂, LiAlCl₄, LiPO₂F₂, LICl, LiI, LIN(SO₃C₂F₅)₂, Li(FSO₂)₂N (lithium bis(fluorosulfonyl)imide, LiFSI), LIC₄F₉SO₃, LIN(CxF₂x+1SO₂)(CyF₂y+1SO₂) (where x and y are integers from 1 to 20), lithium trifluoromethane sulfonate, lithium tetrafluoroethanesulfonate, lithium difluorobis(oxalato)phosphate (LiDFOB), and lithium bis(oxalato) borate (LiBOB).

Depending on the type of battery cell 100, the separator may be present between the positive electrode and the negative electrode. As the separator, polyethylene, polypropylene, polyvinylidene fluoride, or a multilayer film of two or more layers thereof may be used, and, in an embodiment, a mixed multilayer film, such as a two-layer separator of polyethylene/polypropylene, a three-layer separator of polyethylene/polypropylene/polyethylene, or a three-layer separator of polypropylene/polyethylene/polypropylene may be used.

The separator may include a porous substrate, and a coating layer including an organic material, an inorganic material, or a combination thereof located on one surface or both, or opposite, surfaces of the porous substrate.

The porous substrate may be a polymer film formed of any polymer selected from polyolefins, such as polyethylene and polypropylene, polyesters, such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyether sulfone, a polyphenylene oxide, a cyclic olefin copolymer, polyphenylene sulfide, polyethylene naphthalate, glass fiber, and polytetrafluoroethylene (e.g, Teflon), or a copolymer or a mixture of two or more thereof.

The organic material may include a polyvinylidene fluoride-based polymer or a (meth)acrylic-based polymer.

In an embodiment, the inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present invention is not limited thereto.

The organic and inorganic materials may be present as a mixture in one coating layer, or may be present in a form in which a coating layer containing an organic material and a coating layer containing an inorganic material are stacked.

The battery cell 100 according to an embodiment of the present invention includes an electrode assembly, the case 120, and/or the tab 110. The battery cell 100 may further include a pair of cap plates 130.

In FIGS. 1 and 2, a battery cell 100 having a prismatic shape is illustrated, but a shape of the battery cell 100 according to one or more embodiments of the present invention is not limited thereto. The battery cell 100 may be formed in any shape in which a pair of tabs extend from at least one side, and, for example, the battery cell 100 may be pouch-shaped. Herein, as a lithium-ion secondary battery, the battery cell 100 with a prismatic shape will be described as an example.

An electrode assembly includes a first electrode, a second electrode, and a separator disposed between the first electrode and the second electrode. The first electrode includes, for example, a positive electrode or a negative electrode. The second electrode includes, for example, a negative electrode or a positive electrode.

In an embodiment, the electrode assembly is formed by stacking the first electrode, the second electrode, and the separator. For example, the electrode assembly may form a jelly-roll by winding the stacked first electrode, second electrode and separator, or, for example, the electrode assembly may form a stack by stacking the first electrode, the second electrode, and the separator.

The case 120 forms the overall appearance of the battery cell 100. For example, the case 120 may include a conductive metal, such as aluminum, an aluminum alloy, nickel-plated steel, stainless steel, SUS304, or carbon steel.

The case 120 may provide a space that accommodates an electrode assembly, and the case 120 accommodates the electrode assembly. The case 120 protects the electrode assembly from external impacts. The case 120 may perform a heat dissipation function to release heat resulting from the charge/discharge operation of the electrode assembly to the outside.

In an embodiment, the case 120 includes a pair of narrow sides 121 and 122 and a pair of wide sides 123.

The pair of narrow sides 121 and 122 face each other. For example, the narrow sides include a first narrow side 121 and a second narrow side 122 facing the first narrow side 121. In an embodiment, each of the pair of narrow sides 121 and 122 may have, for example, a generally rectangular plate shape. Here, the pair of narrow sides 121 and 122 may have, for example, similar or same areas.

The pair of wide sides 123 are formed facing each other. In FIGS. 1 and 2, only one of the pair of wide sides 123 facing each other is illustrated. Each of the pair of wide sides 123 may have a generally rectangular plate shape. Here, the pair of wide sides 123 may have, for example, similar or same areas. In an embodiment, the pair of wide sides 123 may be, for example, formed to have an area larger than at least one of the pair of narrow sides 121 and 122.

Each wide side 123 is connected to an edge of the narrow side 121 or 122. For example, an edge of one wide side 123 is connected to the first narrow side 121. In addition, another edge of the wide side 123 is connected to the second narrow side 122. In addition, for example, an edge of the other wide side 123 is connected to the first narrow side 121. In addition, another edge of the wide side 123 is connected to the second narrow side 122. Due to this structure, the pair of narrow sides 121 and 122 and the pair of wide sides 123 may be connected to one another.

The case 120 has openings. For example, the case 120 may have a first opening provided at one side of the pair of narrow sides 121 and 122 and the pair of wide sides 123 and a second opening provided at the other side. The first opening and the second opening may be, for example, facing each other.

The pair of cap plates 130 may include a first cap plate 130P and a second cap plate 130N, facing each other.

Each cap plate 130 is combined with each opening. For example, the first cap plate 130P is combined with the first opening, and the second cap plate 130N is combined with the second opening.

The tabs 110 are electrically connected to the electrode assembly. The tabs 110 are exposed to the outside such that the electrode assembly can be electrically connected to the outside. For example, the tabs 110 may be electrically connected to bus bars. The tabs 110 may be referred to as, for example, terminals. That is, the tabs 110 may include all components electrically connected to the electrode assembly and exposed to the outside of the secondary battery 100.

The tabs 110 include, for example, a first tab 110P and a second tab 110N. The first tab 110P is electrically connected to the first electrode. The second tab 110N is electrically connected to the second electrode.

The cap plate 130 may provide a space in which the tab 110 can protrude outside the secondary battery 100. For example, the first tab 110P passes through the first cap plate 130P and is exposed to the outside, and the second tab 110N passes through the second cap plate 130N and is exposed to the outside.

Here, as shown in FIGS. 1 and 2, the first tab 110P and the second tab 110N may be exposed by extending in opposite directions. However, unlike those shown in FIGS. 1 and 2, the first tab 110P and the second tab 110N may be exposed by extending in a same direction. In this case, the cap plate 130 may include only one cap plate. In an embodiment, the secondary battery 100 may not include separate cap plates 130, and the first tab 110P and the second tab 110N may be exposed to the outside of the case 120. Here, the case 120 may be formed in a pouch shape.

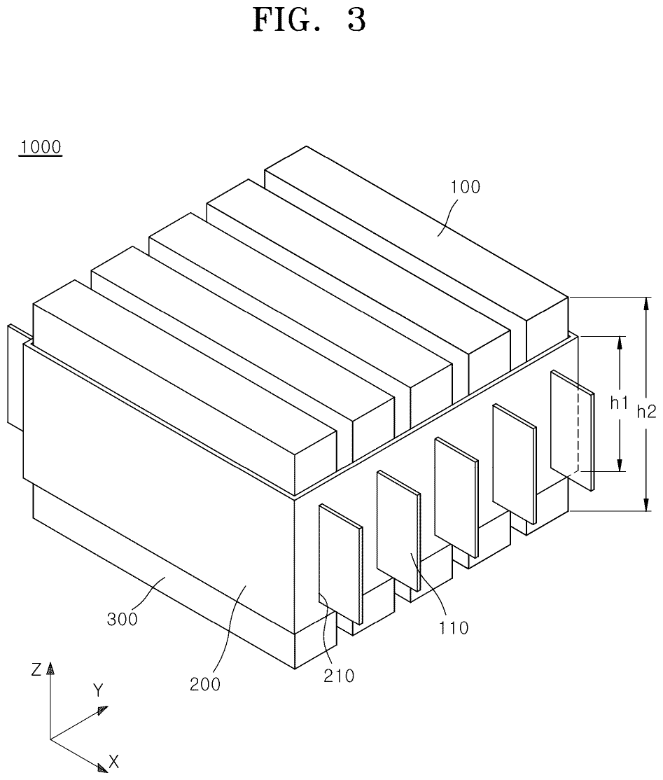

FIG. 3 is a perspective view that schematically illustrates a battery module according to an embodiment of the present invention.

A battery module 1000 according to an embodiment of the present invention includes a cell assembly 300 including a plurality of battery cells 100; and a band 200 that includes an elastic material and surrounds the cell assembly 300 while applying pressure.

The battery module 1000 includes a plurality of battery cells 100. The battery cell 100 may be a unit structure that stores and/or provides electrical power in the battery module 1000. In an embodiment, the battery module 1000 includes one or more cell assemblies 300. Accordingly, the battery module 1000 may charge/discharge electrical energy with a higher capacity than a single battery cell 100.

The cell assembly 300 includes the plurality of battery cells 100.

The plurality of battery cells 100 are arranged, for example, in a longitudinal direction (Y). For example, the battery cell 100 includes a first side; and a second side, which face each other. Here, the first side and the second side include wide surfaces of the sides of the battery cell 100. For example, one of the plurality of battery cells 100 may be arranged such that the first side faces the second side of another battery cell adjacent to the corresponding battery cell. Here, the longitudinal direction (Y) may be a direction toward the second side from the first side. For example, the longitudinal direction (Y) may be a direction in which a greatest volume change of the battery cell 100 occurs if the battery cell 100 is swollen.

In FIG. 3, an example of the battery module 1000 including one cell assembly 300 is illustrated, but a number of the cell assemblies 300 that can be included in the battery module 1000 is not limited thereto. For example, the battery module 1000 may include two or more cell assemblies 300. Here, one cell assembly 300 is a unit structure that includes a plurality of battery cells 100 and is pressed by the band 200. In addition, if the battery module 1000 includes a plurality of cell assemblies 300, although not illustrated, the battery module 1000 may further include an additional band that surrounds and pressurizes the plurality of cell assemblies 300. In addition, when the battery module 1000 includes a plurality of cell assemblies 300, the battery module 1000 may include a housing that accommodates the plurality of cell assemblies 300, and a method by which the battery module 1000 accommodates and/or binds the plurality of cell assemblies 300 is not limited.

The band 200 is provided to surround the cell assembly 300. For example, the band 200 is provided to surround at least a part of the sides of the cell assembly 300. For example, the band 200 surrounds four directions of the sides of the cell assembly 300 and binds the plurality of battery cells 100 included in the cell assembly 300. Accordingly, the band 200 may bind the plurality of battery cells 100 to form the cell assembly 300.

In addition, the band 200 may pressurize the cell assembly 300. In an embodiment, the band 200 includes an elastic material. For example, the band 200 may include an elastic material having a breaking strength of 50 MPa or greater.

To absorb and/or prevent or substantially prevent swelling that may occur in the cell assembly 300, the elastic material has, for example, durability and/or elasticity. In an embodiment, the elastic material includes, for example, at least one selected from the group consisting of a rubber, a polymer resin, a thermoplastic resin, a metal, and a combination thereof.

The rubber may include, for example, one or more selected from the group consisting of butadiene rubber, styrene butadiene rubber, acrylonitrile butadiene rubber, chloroprene rubber, polyisoprene rubber, an isobutylene isoprene copolymer, ethylene propylene rubber, an ethylene vinylacetate copolymer, chlorinated polyethylene, chlorosulfonated polyethylene, acrylic rubber, an ethylene acrylate copolymer, a fluoroelastomer, silicone rubber, a polyurethane elastomer, polyester polyurethane, polyether polyurethane, hydrogenated acrylonitrile-butadiene rubber, acrylonitrile-butadiene rubber, carboxylated acrylonitrile-butadiene rubber, and a combination thereof.

The polymer resin may include, for example, a synthetic fiber. The polymer resin may include, for example, one or more selected from the group consisting of a polyolefin-based resin, polyethylene, polypropylene, polyimide, polybutylene terephthalate, polytetrafluoroethylene, polystyrene, vinyl chloride, vinylidene chloride, a fluororesin, an acrylic resin, a polyvinyl acetate resin, a polyamide resin, polycarbonate, an acetal resin, polyphenylene oxide, polyester, polysulfone, nylon, and a combination thereof.

The metal may include, for example, one or more selected from the group consisting of SUS, titanium, aluminum, and an alloy thereof.

In an embodiment, for example, the band 200 may be formed such that the surface facing the cell assembly 300 is flat in correspondence with the cell assembly 300. To this end, the band 200 may be formed in a shape that is highly efficient to manufacture and can pressurize the cell assembly 300. In an embodiment, for example, the band 200 may have pores, or may be formed in a mesh structure. Accordingly, the band 200 may effectively absorb and/or prevent or substantially prevent swelling.

The band 200 is formed to have a first height h1, and the cell assembly 300 is formed to have a second height h2. Here, the height represents the distance in the height direction (Z) of the corresponding component.

In an embodiment, the first height h1 is less than the second height h2. In an embodiment, for example, the first height h1 is 40% or greater and 100% or less of the second height h2. In an embodiment, for example, the first height h1 is 45% or greater and 100% or less than the second height h2. In an embodiment, for example, the first height h1 is 50% or greater and 100% or less than the second height h2. In an embodiment, for example, the first height h1 is 55% or greater and 100% or less than the second height h2. In an embodiment, for example, the first height h1 is 60% or greater and 100% or less than the second height h2. In an embodiment, for example, the first height h1 is 65% or greater and 100% or less than the second height h2. In an embodiment, for example, the first height h1 is 70% or greater and 100% or less than the second height h2.

If the first height h1 is greater than 100% of the second height (h2), the capacity efficiency of the battery module 1000 may be reduced by the band 200. If the first height h1 is less than 40% of the second height h2, the band 200 may not provide a sufficient pressing force to the cell assembly 300.

The band 200 may be formed to cover most of the region of the side of the cell assembly 300, and, for example, the band 200 may have a height of 30% or greater than the height of the cell assembly 300. In an embodiment, a ratio of the region facing the band 200 to the entire region of the side of the cell assembly 300 may be 40% or greater and 100% or less. In an embodiment, for example, the ratio of the region facing the band 200 to the entire region of the side of the cell assembly 300 may be 50% or greater and 100% or less. In an embodiment, for example, the ratio of the region facing the band 200 to the entire region of the side of the cell assembly 300 may be 60% or greater and 100% or less. In an embodiment, for example, the ratio of the region facing the band 200 to the entire region of the side of the cell assembly 300 may be 70% or greater and 100% or less.

Therefore, the band 200 may provide a sufficient pressing force to the cell assembly 300. In an embodiment, the band 200 may provide a uniform or substantially uniform pressing force to the cell assembly 300 in all directions.

Due to this structure, the battery module 1000 according to an embodiment of the present invention may prevent or substantially prevent permanent deformation of the battery cell 100 and/or the battery module 1000 by swelling, and resolve various problems that may occur due to a pressure imbalance.

In addition, the battery module 1000 may secure the plurality of battery cells 100 and/or the cell assembly 300 using the band 200, thereby fixing the plurality of battery cells 100 without an additional component, such as a separate module case or plate. Accordingly, the battery module 1000 may provide a method of improving manufacturing efficiency and cost.

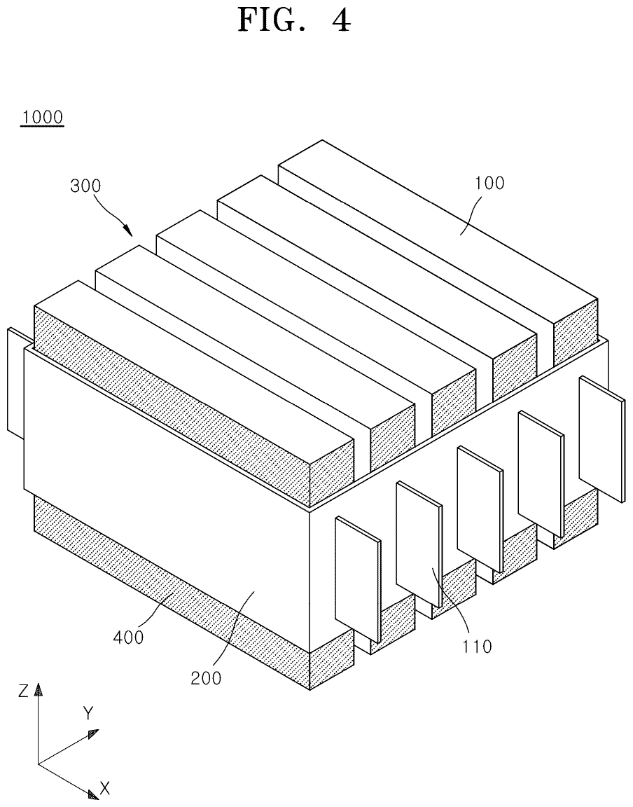

FIG. 4 is a perspective view that schematically illustrates a battery module according to an embodiment of the present invention.

The battery module 1000 according to an embodiment of the present invention includes a protective member 400 that is located between a cell assembly 300 and a band 200, and pressurizes the cell assembly 300.

The protective member 400 may protect the cell assembly 300 between a force of expansion of the inside of the cell assembly 300 and a pressing force on the outside of the cell assembly 300 by the band 200. For example, if the battery cell 100 has a pouch cell shape, the shape of the cell assembly 300 may be deformed by the pressing force of the band 200. The protective member 400 may prevent or substantially prevent the cell assembly 300 from being deformed by the pressing force of the band 200 while allowing the band 200 to absorb and/or prevent or substantially prevent swelling of the cell assembly 300.

In an embodiment, the protective member 400 has high flexural strength. In an embodiment, for example, the protective member 400 has a flexural strength of 200 MPa or greater. Here, the flexural strength is based on ASTM D790. Therefore, even if a high mechanical load is applied to the cell assembly 300 by the band 200, the protective member 400 may effectively protect the cell assembly 300.

The protective member 400 may include, for example, a first material. For example, the first material may include fibers. Here, the fibers may include, for example, at least one or a mixture of at least two selected from the group consisting of fibrous inorganic materials, such as glass wool, rock wool, gypsum fiber, silica fiber, alumina fiber, zirconia fiber, and carbon fiber. In an embodiment, the fibers include, for example, at least one or a mixture of at least two selected from the group consisting of fibrous metal materials, such as gold, silver, iron, steel, aluminum, beryllium, tungsten, molybdenum, and stainless steel.

In an embodiment, the protective member 400 may include, for example, a second material. For example, the second material may include at least one or a mixture of at least two selected from the group consisting of ABS, SAN, polystyrene, MPPO, polycarbonate, polysulfone, polyetherimide, polypropylene, polyethyene (HDPE), acetal, PBT, Nylon 6, Nylon 66, Nylon 46, Nylon 610, Nylon 612, Nylon 11, Nylon 12, amorphous nylon, polyetheretherketone, polyphenylene sulfide, and polyphthalamide (PPA).

In an embodiment, the protective member 400 may include, for example, a mixture of the first material and the second material.

The protective member 400 may be formed, for example, in a plate shape. For example, the protective member 400 may be formed in a plate shape and interposed between the band 200 and the cell assembly 300. In an embodiment, for example, the protective member 400 may be formed in a plate shape and fixed to the band 200 and/or the cell assembly 300.

In an embodiment, the protective member 400 may be formed by coating the outer surface of the cell assembly 300. For example, the protective member 400 may be formed by coating at least a part of the outer surface of the cell assembly 300.

In an embodiment, for example, the protective member 400 may be formed corresponding to at least a part of the outer surface of the cell assembly 300, and/or formed by coating at least a part of the outer surface of the cell assembly 300. For example, the protective member 400 may be provided on the outer surface of the cell assembly 300 in a region wider than the band 200, but the size and/or area of the protective member 400 are not limited thereto.

In this way, the battery module 1000 according to an embodiment of the present invention may prevent or substantially prevent the shape of the cell assembly 300 and/or the battery cell 100 included in the cell assembly 300 from being deformed by the band 200.

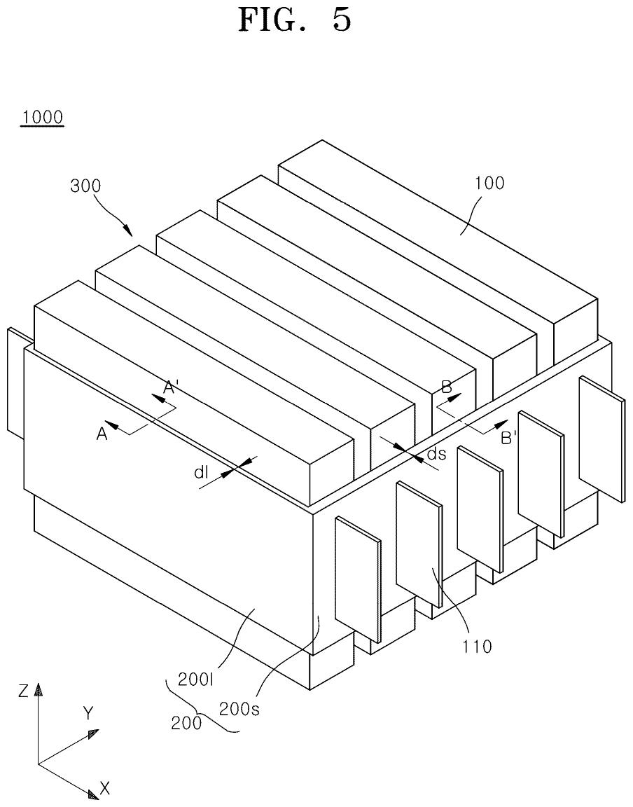

FIG. 5 is a perspective view that schematically illustrates a battery module according to an embodiment of the present invention.

A band 200 according to an embodiment of the present invention includes a pair of band short sides 200s covering at least a part of a pair of cap plates; and a pair of band long sides 200l that covers at least a part of wide sides and is connected to the pair of band short sides 200s.

The band 200 may be formed in an “ [symbol] ” shape, for example, when viewed from above. In this case, the band 200 may have the inner surface of each side of the “ [symbol] ” shape facing an outer surface of a cell assembly 300. In an embodiment, the band 200 may be formed in a circular, oval, or irregular shape, for example, when viewed from above. In this case, the band 200 may be formed in a shape the same or similar to the “ [symbol] ” shape by surrounding the cell assembly 300 and fitting the outer surface of the cell assembly 300.

In an embodiment, for example, the band 200 includes a pair of band short sides 200s and a pair of band long sides 200l. Here, the pair of band short sides 200s may be formed facing each other. Here, the pair of band long sides 200l may be formed facing each other. Here, one band long side 200l may connect one side of one band short side 200s and one side of the other band short side 200s. Here, the other band long side 200l may connect the other side of the one band short side 200s and the other side of the other band short side 200s.

The band short side 200s surrounds one of the sides of a cell assembly 300. For example, as described above, the cell assembly 300 may be formed by arranging the plurality of battery cells 100 in parallel. Accordingly, cap plates 130 included in the plurality of battery cells 100 are exposed at a pair of sides of the cell assembly 300 opposite to each other. The band short side 200s includes a region of the band 200 which covers the cap plates 130.

The band long side 200l surrounds one of the sides of the cell assembly 300. For example, as described above, the cell assembly 300 is formed by arranging the plurality of battery cells 100 in parallel. Therefore, at least two of the plurality of battery cells 100 form the front side of the cell assembly 300 and the back side of the cell assembly 300, respectively. For example, one wide side of the plurality of battery cells 100 forms the front side of the cell assembly 300. For example, the other wide side of the plurality of battery cells 100 forms the back side of the cell assembly 300. Here, the front and back sides of the cell assembly 300 include surfaces in the X-Z plane, located opposite to each other. The band long side 200l includes a region of the band 200, which covers the wide side of the battery cell 100.

The band short side 200s is a region that covers the cap plate 130 and may receive stress from the tab 110. Accordingly, in an embodiment, the band short side 200s has a higher strength than the band long side 200l.

Accordingly, in an embodiment, the band short side 200s may be formed relatively thick. In an embodiment, for example, a thickness ds of the band short side 200s is formed to be equal to or greater than a thickness d1 of the band long side 200l. In an embodiment, for example, the thickness ds of the band short side 200s may be formed to be 1 to 4 times the thickness d1 of the band long side 200l. In an embodiment, for example, the thickness ds of the band short side 200s may be formed to be 1.2 to 3.5 times the thickness of the band long side 200l. In an embodiment, for example, the thickness ds of the band short side 200s may be formed to be 1.4 to 3 times the thickness d1 of the band long side 200l. In an embodiment, for example, the thickness ds of the band short side 200s may be formed to be 1.5 to 2.5 times the thickness d1 of the band long side 200l.

Accordingly, the band 200 may uniformly or substantially uniformly pressurize the cell assembly 300 in consideration of the structure of the cell assembly 300. Herein, some examples of various structures will be described in consideration of the tab 110.

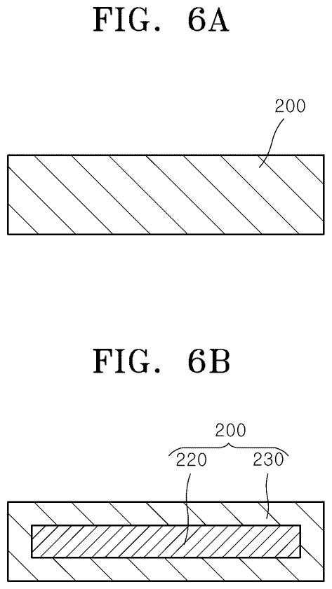

FIGS. 6A and 6B schematically illustrate a band according to an embodiment of the present invention.

FIG. 6A is a cross-sectional view along the line A-A′ of FIG. 5; and FIG. 6B is a cross-sectional view along the line B-B′ of FIG. 5.

As illustrated in FIG. 5, the band 200 according to an embodiment of the present invention includes a band short side 200s and a band long side 200l. In an embodiment, the band short side includes a center 220 including a first material; and an edge 230 that includes a second material with a smaller breaking strength than the first material and surrounds the center 220.

The center 220 is the inside of the band 200. For example, the center 220 is a part that is not exposed to the outside of the band 200. The center 220 contains the first material. The first material is a material with a relatively high breaking strength. The edge 230 is the outside of the band 200. For example, the edge 230 is

a part exposed to the outside of the band 200. For example, the edge 230 is a part that is provided at the outside of the center 220. The edge 230 includes the second material. The second material is a material with a relatively low breaking strength, and in an embodiment, for example, the breaking strength of the second material is equal to or lower than that of the first material.

In an embodiment, the center 220 may be formed through a molding process, such as any of compression molding, extrusion molding, injection molding, blow molding, and vacuum forming. In an embodiment, the edge 230 may be formed through a molding process, such as any of compression molding, extrusion molding, injection molding, blow molding, and vacuum forming. In an embodiment, the edge 230 may be formed by being coated on the center 220.

In an embodiment, the edge 230 may be formed to have a through hole through a molding process, such as compression, extrusion, injection, blowing, or vacuuming. In an embodiment, the center 220 may be formed through a molding process, such as compression molding, extrusion molding, injection molding, blow molding, and vacuum forming. In an embodiment, the center 220 may be formed through injection into the through hole formed in the edge 230.

In an embodiment, the band long side 200l may include a second material. In an embodiment, the band long side 200l may be formed of a same material as the edge 230.

In an embodiment, the breaking strength of the first material and the second material is 50 MPa or greater. Therefore, the breaking strength of the second material may be 50 MPa or greater, and the breaking strength of the first material may be equal to or greater than that of the second material.

Due to this structure, the band short side 200s is formed with a greater breaking strength than the band long side 2201. Therefore, the band 200 according to an embodiment of the present invention may improve the durability of the band 200 and provide a uniform or substantially uniform pressing force to the cell assembly 300.

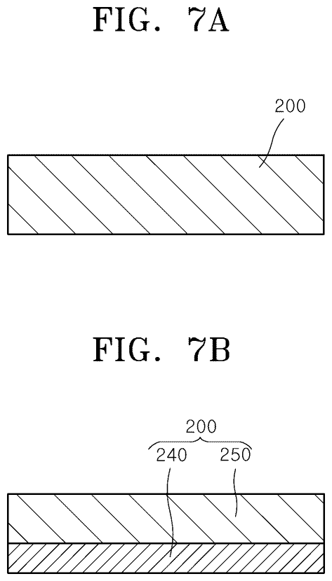

FIGS. 7A and 7B schematically illustrate a band according to an embodiment of the present invention.

As illustrated in FIG. 5, a band 200 according to an embodiment of the present invention includes a band short side 200s and a band long side 200l. In an embodiment, the band short side 200s includes an inner part 240 that includes a first material and faces the cell assembly 300; and an outer part 250 that includes a second material having a smaller breaking strength than the first material and is located outside the inner part 240.

The inner part 240 is the inner side of the band 200. For example, the inner part 240 is the part of the band 200 that faces the cell assembly 300. The inner part 240 includes a first material. The first material is a material having a relatively high breaking strength.

The outer part 250 is the outer side of the band 200. For example, the outer part 250 is the part of the band 200 which faces the opposite direction to the cell assembly 300. The outer part 250 includes a second material. The second material is a material having a relatively low breaking strength, and, in an embodiment, the breaking strength of the second material is equal to or less than that of the first material.

In an embodiment, the inner part 240 may be formed through a molding process, such as any of compression molding, extrusion molding, injection molding, blow molding, and vacuum forming. In an embodiment, the outer part 250 may be formed through a molding process, such as any of compression molding, extrusion molding, injection molding, blow molding, and vacuum forming. The outer part 250 may be stacked on the inner part 240. In an embodiment, for example, the outer part 250 may be fixed on the inner part 240 using an adhesive material. In an embodiment, the outer part 250 may be formed by being coated on the inner part 240.

The adhesive material may include an adhesive substance. For example, the adhesive substance may include at least one of a silicon-based resin, an acrylic resin, a urethane-based resin, a rubber-based resin, an epoxy resin, a polyolefin, and a combination thereof.

For example, the acrylic resin may include acryl, an ester copolymer, ethyl acrylate, butylacrylate, hexylacrylate, n-octylacrylate, isooctylacrylate, 2-ethylhexylacrylate, isononylacrylate, lauryl acrylate, acrylic acid, maleic acid, fumaric acid, itaconic acid, crotonic acid, acrylamide, N-vinylpyrrolidone, N-vinyl caprolactam, acrylonitrile, acryloyl morpholine, 2-hydroxylethyl acrylate, 2-hydroxypropyl acrylate, 2-hydroxybutylacrylate, etc.

For example, the urethane-based resin may include, for example, polyurethane.

For example, the rubber-based resin may include natural rubber, synthetic rubber, etc.

Here, the band long side 200l may include a second material. In an embodiment, the band long side 200l may be formed of a same material as the edge 230.

In an embodiment, the breaking strength of the first material and the second material is 50 MPa or greater. Accordingly, the breaking strength of the second material may be 50 MPa or greater, and, in an embodiment, the breaking strength of the first material may be equal to higher than that of the second material.

Due to this structure, the band short side 200s is formed with a higher breaking strength than the band long side 2201. Therefore, the band 200 according to an embodiment of the present invention may improve durability of the band 200, and provide a uniform or substantially uniform pressing force to the cell assembly 300.

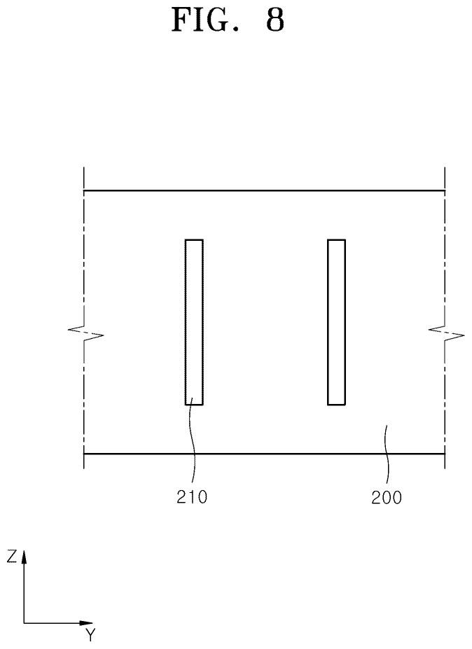

FIG. 8 schematically illustrates a band according to an embodiment of the present invention.

As illustrated in FIG. 5, a band 200 according to an embodiment of the present invention includes a band short side 200s and a band long side 200l. The band 200 may further include holes 210 that are formed in the band short side 200s and through which a pair of tabs 130 pass.

The holes 210 are formed through the band short side 200s. The holes 210 allow the tabs 110 to pass through the band short side 200s and be exposed to the outside.

The holes 210 may be formed corresponding to a size and/or shape of the tabs 110. For example, the tabs 110 may be formed in a rectangular shape, and, in this case, the holes 210 may be formed in a rectangular shape corresponding to the shape of the tabs 110. For example, the tabs 110 may be formed in a thin plate shape, and, in this case, the holes 210 may be formed in a thin slit shape through which the tabs 110 can pass. In an embodiment, the holes 210 may be formed to a size approximately larger than the tabs 110 such that the tabs 110 can pass through the holes 210 while the band 200 can evenly pressurize the cell assembly 300.

In an embodiment, for example, as shown in FIG. 8, when a battery module 1000 is viewed in the Y-Z plane, the area of the hole 210 may be formed to be 1.01 to 2.00 times the area of the tab 110. In an embodiment, for example, the area of the hole 210 may be formed to be 1.01 to 1.99 times the area of the tab 110. In an embodiment, the area of the hole 210 may be formed to be 1.10 to 1.90 times the area of the tab 110.

Therefore, the band 200 according to an embodiment of the present invention may pressurize a cell assembly 300 while covering a cap plate 130 formed by protruding the tab 110. For example, even if the battery module 1000 includes a plurality of battery cells 100 having a side terminal structure, a method of pressurizing the cell assembly 300 using the band 200 is provided.

Herein, some examples of preventing or substantially preventing the pressing force of the band 200 to the cell assembly 300 from being reduced or the band 200 from non-uniformly pressurizing the cell assembly 300 and/or improving the durability of the band 200 even when the band 200 includes the holes 210 will be described.

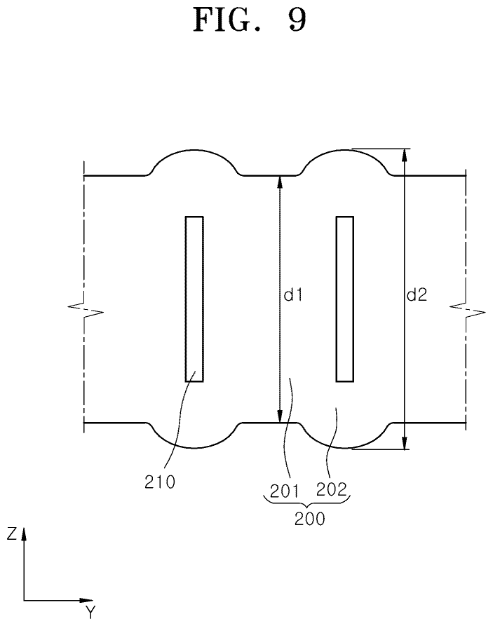

FIG. 9 schematically illustrates a band according to an embodiment of the present invention.

As illustrated in FIG. 9, for example, in a band short side 200s, a region in which a hole 210 is formed may be formed higher than a region in which a hole 210 is not formed.

In an embodiment, although not illustrated in FIG. 9, for example, in the band short side 200s, a height d2 of a hole adjacent part 202 which is adjacent to the hole 210 may be formed longer than a height d1 of a hole non-adjacent part 201 which is not adjacent to the hole 210.

The band short side 200s includes the hole adjacent part 202 and the hole non-adjacent part 201.

The hole adjacent part 202 is a region in which the hole 210 is located in the height direction (Z) in the band 200. For example, the hole adjacent part 202 includes regions corresponding to the portions above and below the hole 210 in the band 200. Here, the hole adjacent part 202 may further include regions on the left and/or right of the hole 210 in the band 200. The hole non-adjacent part 201 is a region in which the hole 210 is not located in the height direction (Z) in the band 200.

When the holes 210 are formed in the band 200, the heights of the portions above and below the region in which the hole 210 is formed become thinner. The durability and pressing force may be different between the hole adjacent part 202 and the hole non-adjacent part 201 in the band 200.

Accordingly, the total height d2 of the hole adjacent part 202 may be formed longer than the height d1 of the hole non-adjacent part 201.

Due to this structure, a battery module 1000 may improve durability of the band 200 in which the holes 210 are formed, and/or the band 200 may provide a uniform or substantially uniform pressing force to the cell assembly 300.

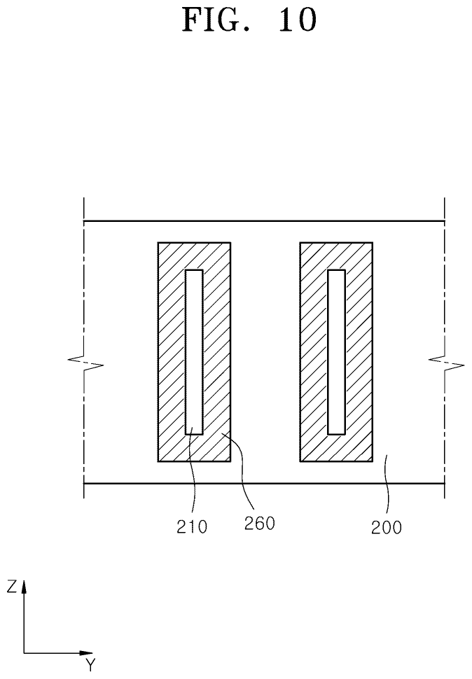

FIG. 10 schematically illustrates a band according to an embodiment of the present invention.

As illustrated in FIG. 10, for example, a band short side 200s may further include a finishing member 260 located adjacent to a hole 210.

The finishing member 260 may prevent or substantially prevent a force from being applied to a band 200 located adjacent to a tab 110. In an embodiment, for example, the finishing member 260 prevents or substantially prevents a pressing force of the band 200 from being reduced by the hole 210.

To this end, the finishing member 260 is formed adjacent to the hole 210. For example, the finishing member 260 is formed on at least one of the upper, lower, left, and right sides of the tab 110 passing through the hole 210.

In an embodiment, for example, the finishing member 260 is manufactured by molding. In this case, the finishing member 260 may be joined to the hole 210 and fixed to the band 200. In an embodiment, the finishing member 260 may be formed by being coated on the band 200 adjacent to the hole 210. In an embodiment, the finishing member 260 may be formed by being adhered to the band adjacent to the hole 210.

In an embodiment, for example, the finishing member 260 includes one or more selected from the group consisting of a rubber, a polymer resin, a metal, and a combination thereof. In an embodiment, if the finishing member 260 is formed by being adhered to the band 200 adjacent to the hole 210, the finishing member 260 may further include an adhesive material that adheres the finishing member 260 to the band 200.

Due to this structure, a battery module 1000 may improve durability of the band 200 in which the holes 210 are formed.

In FIGS. 8 to 10, examples of the holes 210 formed in the band short side 200s of the band 200 and for reinforcing the strength of the holes 210 are illustrated. However, the band 200 according to one or more embodiments of the present invention is not limited to the configurations shown in FIGS. 8 to 10.

For example, at least one of the examples illustrated in FIGS. 5 to 7 may be applied to the band short side 200s in which the holes 210 are formed. In an embodiment, for example, the band short side 200s in which the holes 210 are formed may be formed thicker than the band long side 200l. In an embodiment, for example, the band short side 200s in which the holes 210 are formed may include a center containing a first material and an edge containing a second material. In an embodiment, for example, the band short side 200s in which the holes 210 are formed may include an inner part containing a first material and an outer part containing a second material.

In an embodiment, at least one of the examples illustrated in FIGS. 5 to 7 and at least one of the examples illustrated in FIGS. 8 to 10 may be combined and applied. For example, the band short side 200s in which the holes 210 are formed may include a center containing a first material; an edge containing a second material; and a finishing member located adjacent to the hole.

Further, at least two of the examples illustrated in FIGS. 5 to 10 may be combined and applied. In an embodiment, for example, in the band 200, the thickness of the band short side 200s is formed thicker than that of the band long side 200l, and the band short side 200s may include a center containing a first material and an edge containing a second material.

Due to this structure, the battery module 1000 according to an embodiment of the present invention may provide a method for maintaining a uniform or substantially uniform pressure even if pressure is changed by swelling.

Although the present invention has been described with reference to some example embodiments and drawings, the present invention is not limited thereto, and it will be understood by those of ordinary skill in the art to which the present invention pertains that various modifications and variations are possible within the scope of the technical idea of the present invention and the equivalent scope of the claims.

What is claimed is:

1. A battery module, comprising:
a cell assembly comprising a plurality of battery cells; and
a band that comprises an elastic material, and surrounds the cell assembly while applying pressure,
wherein each of the plurality of battery cells comprises
a case; and
a pair of tabs extending from at least one side of the case and passing through the band.

2. The battery module as claimed in claim 1, wherein the case comprises a pair of narrow sides facing each other; and a pair of wide sides connecting the pair of narrow sides, and
the battery cell comprises a pair of cap plates which are connected to a first opening in a side of the case and a second opening in another side of the case, the pair of cap plates comprising a pair of protruding tabs.

3. The battery module as claimed in claim 2, wherein the band comprises:
a pair of band short sides covering at least a part of the pair of cap plates; and
a pair of band long sides covering at least a part of the pair of wide sides and connected to the pair of band short sides.

4. The battery module as claimed in claim 3, wherein each of the pair of band short sides is thicker than a band long side of the pair of band long sides.

5. The battery module as claimed in claim 3, wherein each of the pair of band short sides comprises a center comprising a first material; and
an edge comprising a second material having a lower breaking strength than the first material and surrounding the center.

6. The battery module as claimed in claim 3, wherein each of the pair of band short sides comprises an inner part comprising a first material and facing the cell assembly; and
an outer part comprising a second material having a lower breaking strength than the first material, and located outside the inner part.

7. The battery module as claimed in claim 3, wherein the band comprises holes which are formed in the band short side and through which the pair of tabs pass.

8. The battery module as claimed in claim 7, wherein, in the band short side, a region in which a hole of the holes are formed is higher than a region in which the hole is not formed.

9. The battery module as claimed in claim 7, wherein the band short side further comprises a finishing member adjacent to a hole of the holes.

10. The battery module as claimed in claim 7, wherein, in the band short side, a height of a hole adjacent part that is adjacent to a hole of the holes is longer than that of a hole non-adjacent part that is not adjacent to the hole.

11. The battery module as claimed in claim 1, wherein the band has a height of 40% or greater of a height of the cell assembly.

12. The battery module as claimed in claim 1, wherein the band comprises at least one selected from the group consisting of a rubber, a polymer resin, a metal, and a combination thereof.

13. The battery module as claimed in claim 1, wherein the band has a breaking strength of 50 MPa or greater.

14. The battery module as claimed in claim 1, further comprising a protective member which is located between the cell assembly and the band and pressurizes the cell assembly.

15. The battery module as claimed in claim 14, wherein the protective member has a flexural strength of 200 MPa or greater.
